(19) United States
(12) Patent Application Publication
(10) Pub. No.: US 2007/0042734 A1
(43) Pub. Date: Feb. 22, 2007

(54) Tuner and broadcasting signal receiver including the same

(75) Inventors: Jae-young Ryu, Suwon-si (KR); Hyun-koo Kang, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/432,344

(22) Filed: May 12, 2006

(30) Foreign Application Priority Data
Aug. 17, 2005 (KR) 10-2005-0075290

(51) Int. Cl. H04B 1/18

(52) U.S. Cl. 455/182.3; 455/188.1

(57) ABSTRACT

A tuner and a broadcasting signal receiver including the tuner. The tuner includes a band selection module that selects an RF broadcasting signal within the frequency band corresponding to a selected channel, and a low noise amplifier module that amplifies the signal with a specific received signal strength indicator (RSSI) to produce an RF broadcasting signal with a specific gain.

### CROSS-REFERENCE TO RELATED APPLICATION

This application claims priority from Korean Patent Application No. 10-2005-0075290 filed on Aug. 17, 2005 in the Korean Intellectual Property Office, the disclosure of which is incorporated herein by reference in its entirety.

### BACKGROUND OF THE INVENTION

1. Field of the Invention

Apparatuses consistent with the present invention relate to a tuner included in a broadcasting signal receiver that receives terrestrial/cable broadcasting signals, and more particularly, to a tuner with an advanced channel selection method that controls the characteristics of the frequency bands of a band-pass filter and an amplifier concurrently.

2. Description of the Related Art

In line with the development of telecommunication technology, viewers can now enjoy digital broadcasting through satellite, terrestrial, or cable TV channels in their home. In the past, viewers needed a separate network interface module in order to view digital broadcasting, but technological development has enabled the terrestrial and cable broadcasting receivers to receive digital broadcasting signals through a single network interface module.

A tuner is an RF component that must be included in the network interface module; it tunes in and selects the frequencies of certain radio waves.

In general, various types of filters such as a band pass filter and high pass filter, which are at the input ends of the tuner, and a low noise amplifier for controlling the noise while amplifying the strength of signals received from the filter are present inside the tuner. Due to the structure of the tuner, the FM radio band (88-108 MHz) is located in the terrestrial/cable broadcasting band (54-860 MHz) when the terrestrial broadcasting signals are received. Accordingly, to prevent a decline in performance, a notch filter is employed to filter the FM radio frequencies.

FIG. 1 is a block diagram illustrating the structure of a tuner 120 according to the conventional art.

An RF tuning filter 122 receives an RF signal through an antenna and selects a predetermined channel, and rejects image frequency. To conduct such an operation, the RF tuning filter 122 comprises a band-pass filter which is tuned to a certain voltage.

Among the input RF signals, a variable low noise amplifier 124 amplifies the strength of a signal in the terrestrial/cable broadcasting band (54-860 MHz), and controls the noise. In other words, the variable low noise amplifier 124 amplifies signals in this band over the wide range of bands.

Among the RF signals received by the variable low noise amplifier, a notch filter 126 filters out the FM band (88-108 MHz). The notch filter filters terrestrial broadcasting (NTSC/ATSC) signals, but not cable broadcasting signals.

A mixer 140 produces intermediate frequencies by mixing the RF signals from the notch filter 126 and other signals provided by a voltage controlled oscillator (VCO) 130.

FIG. 2 is a block diagram illustrating the structure of a tuner 220 according to another conventional art.

A tracking filter 221 is a band pass filter that selects a channel chosen by a user from among RF broadcasting signals received by the antenna, performs an image-rejection operation, and tunes it using a voltage.

A variable gain low noise amplifier 222 amplifies the signal strength of the RF signals of the broadcasting band (54-860 MHz) passing through the tracking filter 221, and reduces the noise.

An up-mixer 223 raises the frequency of the broadcasting signal amplified by the variable gain low noise amplifier 222 to a first IF frequency (e.g. 1.2 GHz) and an image-rejection filter 224 rejects a part corresponding to the image frequency.

The down-mixer 225 lowers the frequency of the broadcasting signal filtered by the image-rejection filter to a second IF frequency, and an IF amplifier 226 amplifies it by varying the gain of the IF signal.

A double conversion method by which two mixers respectively raise and lower a frequency in a single tuner is employed, according to the conventional technology shown in FIG. 2.

Referring to the structures of the conventional tuners as illustrated in FIG. 1 and FIG. 2, since the variable low noise amplifier 124 in FIG. 1 and the variable gain low noise amplifier 222 in FIG. 2 amplify the frequencies of a wide range of bands, their performance on certain channels may be drastically degraded because the gain of each channel and the noise characteristics are not optimized. When a channel is selected, a tuning operation is performed using a varactor. Specifically, one or both sides of a coil and a condenser are variable, and the inductance of the coil and the capacitance of the condenser can be changed so that they can be tuned into various frequencies.

When the tuner is controlled in this manner, the frequency band of a bandwidth of 6 MHz is not properly selected in the terrestrial/cable broadcasting band (54-860 MHz), and the image-rejection ratio is changed accordingly, thereby causing a decline in performance.

The tuner 120 illustrated in FIG. 1 employs the notch filter in order to control the RF radio signals affecting neighboring channels within the controlled band, which may result in a decline in performance, and a decrease in the receiving sensitivity may be caused as a result of an increase in noise.

The tuner 220 illustrated in FIG. 2 employs the double-conversion method in order to improve the characteristics of the image-rejection, resulting in an increase in power consumption due to the use of an additional mixer.

### SUMMARY OF THE INVENTION

An aspect of the present invention is to improve the characteristics of channel selecting by concurrently controlling the frequency band characteristics of a band pass filter and an amplifier.

Another aspect of the present invention is to optimize gain and noise in the neighboring frequency band of the selected channel using an input/output matching block to a low noise amplifier.

A further aspect of the present invention is to improve performance of a tuner by forming a band pass filter controlled by digital voltages in the channel selection.

A still further aspect of the present invention is to decrease power consumption by simplifying the structure of a tuner.

These and other aspects of the present invention will become apparent to those skilled in the art from the following disclosure.

In accordance with an aspect of the present invention, there is provided a tuner comprising a band selection module that selects an RF broadcasting signal within the frequency band corresponding to a selected channel, and a low noise amplifier module that amplifies the signal with a specific received signal strength indicator (RSSI) to produce an RF broadcasting signal with a specific gain.

In accordance with another aspect of the present invention, there is provided a broadcasting signal receiver comprising a tuner that receives RF broadcasting signals and selects an RF broadcasting signal in the frequency band corresponding to the selected channel, and downshifts the band after amplifying the selected RF broadcasting signal so that the selected RF broadcasting signal has a gain within the band, and a signal processing module that processes a signal in the downshifted band.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram illustrating the structure of a tuner according to the conventional art;

FIG. 2 is a block diagram illustrating the structure of a tuner according to another conventional art;

FIG. 3 is a block diagram illustrating the structure of a broadcasting signal receiver according to an exemplary embodiment of the present invention.

FIG. 4 is a block diagram illustrating the structure of a tuner according an exemplary embodiment of the present invention.

FIG. 5 is a block diagram illustrating the structure of an input matching module and an output matching module according to an exemplary embodiment of the present invention.

FIG. 6 is a block diagram illustrating the structure of an IF signal processing module according to an exemplary embodiment of the present invention.

FIG. 7 is a block diagram illustrating the structure of a tuner control module according to an exemplary embodiment of the present invention.

FIG. 8A to FIG. 8C are graphs illustrating the signal strength in each node.

FIG. 9 is a block diagram illustrating the structure of the broadcasting signal receiver according to another exemplary embodiment of the present invention.

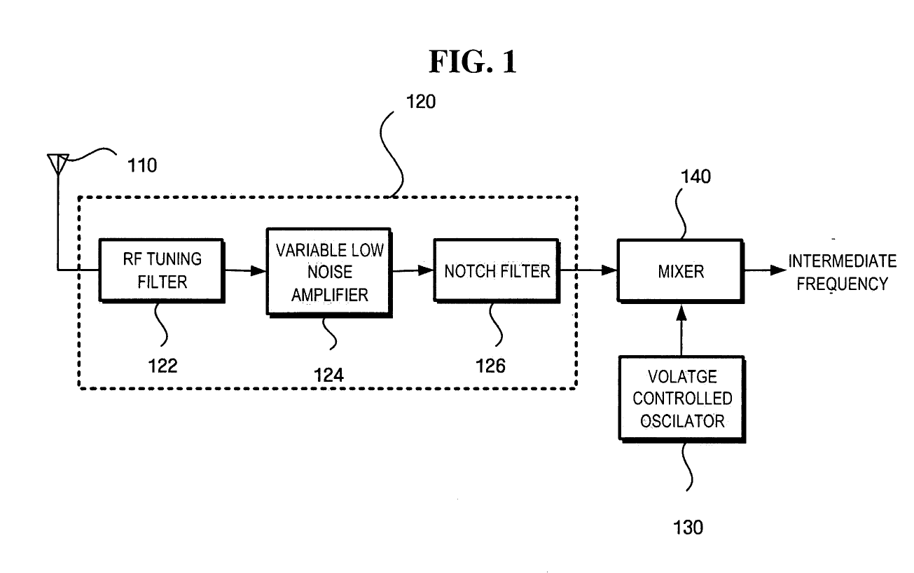

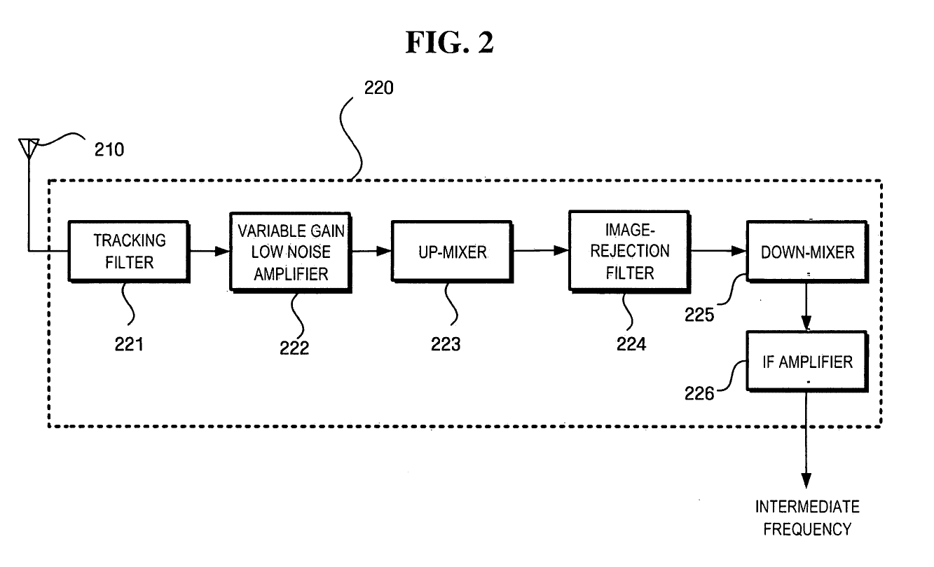

### DETAILED DESCRIPTION OF THE INVENTION

The present invention may be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The present invention is described hereinafter with reference to flowchart illustrations of user interfaces, methods, and computer program products according to exemplary embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which are executed by the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block of the flowchart illustrations may represent a module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in reverse order, depending upon the functionality involved.

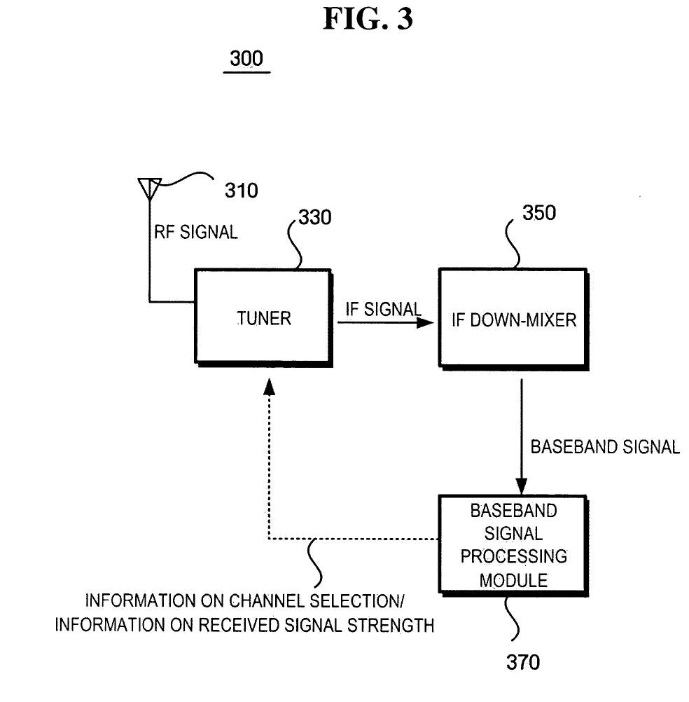

FIG. 3 is a block diagram illustrating the structure of a broadcasting signal receiver according to an exemplary embodiment of the present invention.

As shown in FIG. 3, a broadcasting signal receiver 300 comprises an antenna 310, a tuner 330, an IF down-mixer 350, and a baseband signal processing module 370.

The antenna 310 receives an RF broadcasting signal from the air, converts it into an electrical signal, and transmits the signal via a wire.

The tuner 330 converts the RF broadcasting signal received via the antenna 310 into an IF signal based upon the selected channel and the strength of the received signal. The tuner 330 converts into an IF signal only the RF broadcasting signal belonging to the frequency band according to the channel selection information. The bandwidth of the selected channel for the terrestrial/cable broadcasting services may be 6 MHz.

The IF down-mixer 350 converts the IF signal into a baseband signal, and it may comprise an IF local oscillator.

The baseband signal processing module 370 receives and processes the baseband signal provided by the IF down-mixer 350. The baseband signal processing module 370 may comprise a demodulator in order to demodulate the baseband signal, which conveys the information on the channel selection to the tuner 330. Then, the tuner 330 converts into an IF signal only the RF signal within the frequency band of the selected channel. The baseband signal processing module 370 also controls the strength of the RF signal received through the antenna 310, and the converted IF signal by providing received signal strength indications (RSSIs).

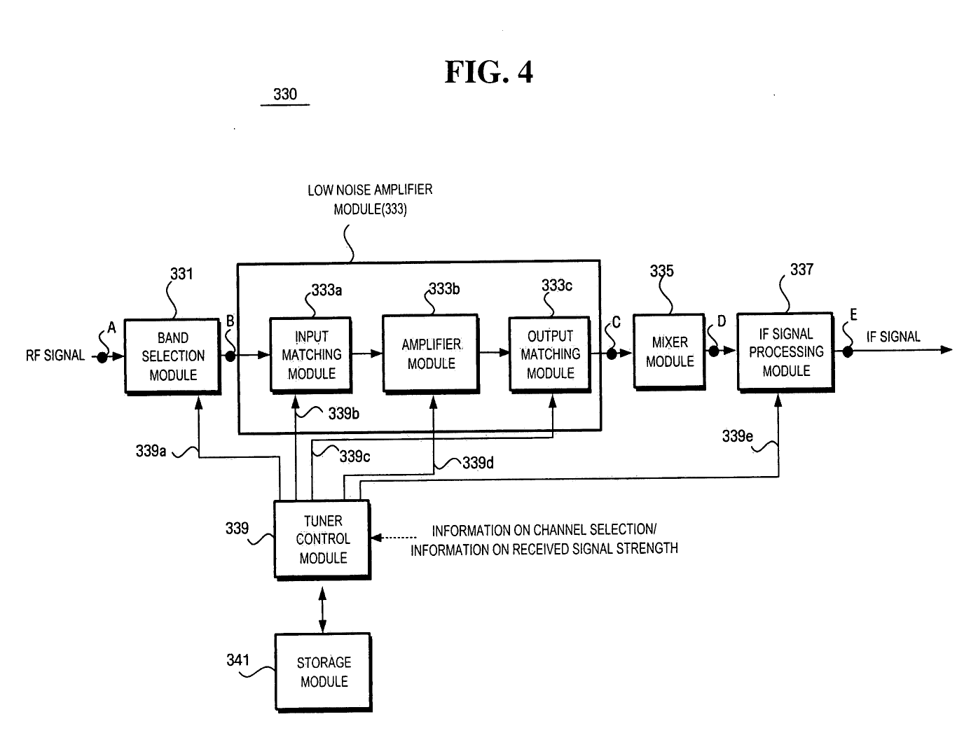

FIG. 4 is a diagram illustrating the structure of a tuner 330 according to an exemplary embodiment of the present invention.

As shown in FIG. 4, the tuner according to an exemplary embodiment of the present invention comprises a band selection module 331, a low noise amplifier module 333, a mixer module 335, an IF signal processing module 337, a tuner control module 339, and a storage module 341.

The term “module”, as used herein, means but is not limited to, a software or hardware component, such as a Field Programmable Gate Array (FPGA) or an Application Specific Integrated Circuit (ASIC), which performs certain tasks. A module may advantageously be configured to reside on the addressable storage medium and configured to be executed by one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

The band selection module 331 filters from the RF broadcasting signal only the signals within the frequency band detailed in the control signal 339a corresponding to information on the channel selection.

The low noise amplifier module 333 amplifies the RF broadcasting signal filtered through the band selection module 331, so that it conforms to the frequency band characteristics of the band selection module 331. In other words, the low noise amplifier module 333 amplifies only the RF broadcasting signal within the band filtered through the band selection module 331.

To conduct such an operation, the low noise amplifier module 333 may comprise an input matching module 333a, an amplifier module 333b, and an output matching module 333c.

The amplifier module 333b amplifies the inputted RF broadcasting signal based upon the control signal 339d, and the input matching module 333a and the output matching module 333c control the band and obtain a specific gain via the amplifier module 333b based upon the control signals 339b and 339c corresponding to the information on the channel selection.

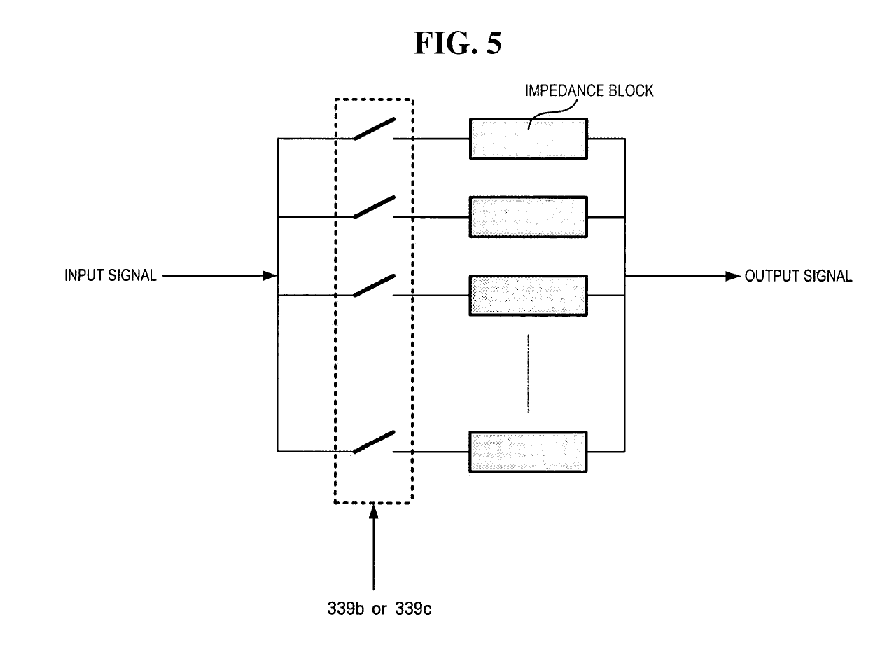

The structures of the input matching module 333a and the output matching module 333c are illustrated in FIG. 5, and the input matching module 333a is described as an example.

The input matching module 333a comprises multiple impedance blocks, and is connected to an individual switching device of each impedance block. The multiple switching devices are shown in the dotted line box in FIG. 5. An impedance block may consist of multiple active devices or multiple passive devices.

Each switching device of the input matching module 333a is turned on or off by the control signal 339b, and an output signal is produced that corresponds to the frequency characteristics produced by the complex impedance of the impedance blocks that have been switched on. In this case, the control signal 339b may be a bit (0 or 1), and the bit may be determined depending upon the number of channels. For example, the control signal 339b is 8 bits when 256 channels are available for selection.

The output matching module 333c can be similarly constructed, and the input matching module 333a and the output matching module 333c can control the band and produce a gain via the amplifier module 333b.

The mixer module 335 converts the RF broadcasting signal amplified by the low noise amplifier module 333 into an IF signal. For this, the mixer module 335 may comprise a local IF oscillator.

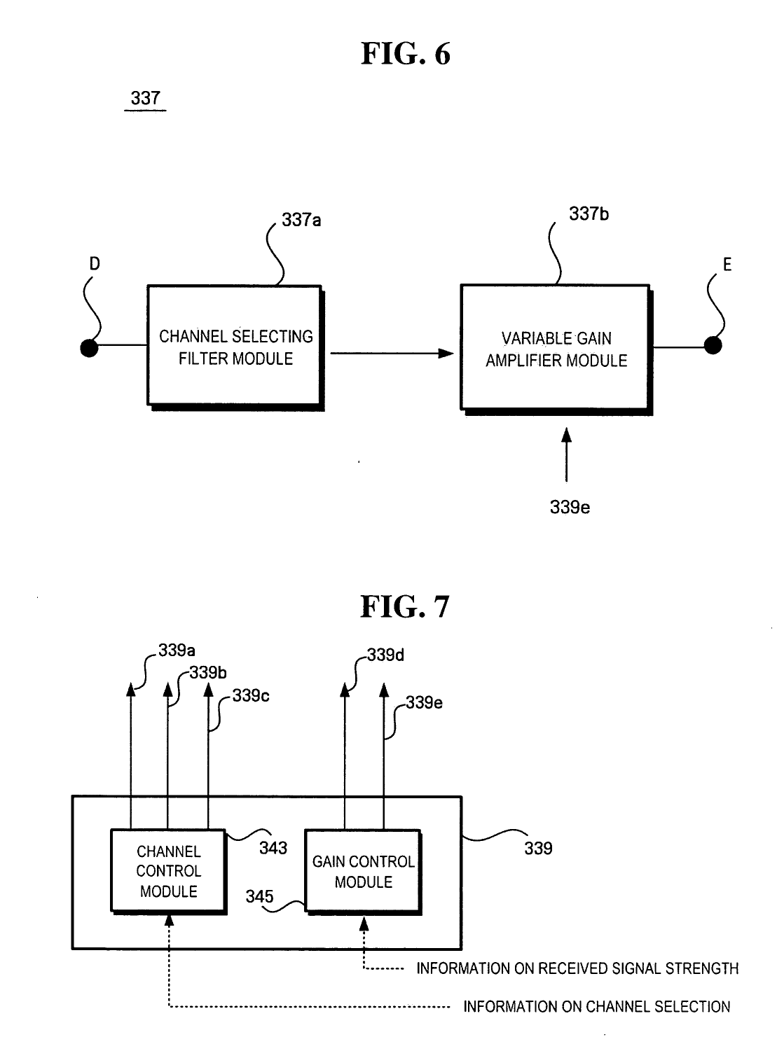

The IF signal processing module 337 comprises the channel selecting filter module 337a and the variable gain amplifier module 337b, as illustrated in FIG. 6.

The channel selecting filter module 337a extracts an intermediate frequency corresponding to the selected channel, and the variable gain amplifier module 337b controls the gain of the signal. That is, the variable gain amplifier module 337b controls the amplitude of the signal inputted according to the RSSI of the control signal 339e. The variable gain amplifier module 337b can be a variable gain amplifier (VGA) or an auto gain control (AGC) amplifier.

As illustrated in FIG. 7, the tuner control module 339 comprises a channel control module 343 and a gain control module 345. The tuner control module 339 receives information on the channel selected by the user and the RSSI from the baseband signal processing module 370, as illustrated in FIG. 3. The channel selection information may be received by the channel control module 343 from the demodulator (not shown) of the baseband signal processing module 370. The RSSI may be received by the gain control module 345.

The channel control module 343 extracts the selected channel information from the storage module 341, and provides the control signals 339a, 339b, and 339c for channel selection to the band selection module 331, the input matching module 333a, and the output matching module 333c, respectively.

The gain control module 345 also provides the control signals 339d and 339e, which contain the RSSIs, to the amplifier module 333b and the variable gain amplifier module 337b of the IF signal processing module 337, respectively.

The storage module 341 may be embodied by a nonvolatile device to store respective bands of the terrestrial broadcasting and the cable broadcasting and corresponding channel numbers, and control bits in the form of a look-up table. Eight control bits are used, which can represent all the terrestrial and cable channels currently available, but the storage module is not limited thereto and may contain any number of bits.

In addition, the gain control module 345 receives gain control information (RSSI), and the gain control module 345 provides the control signals 339d and 339e containing the gain control information.

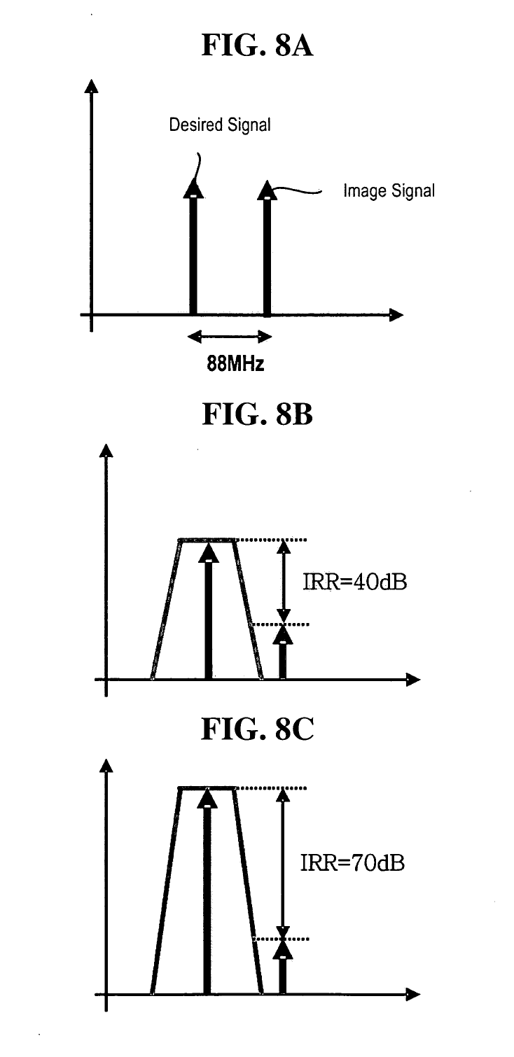

FIG. 8A to FIG. 8C are graphs illustrating the signal strength of each node according to an exemplary embodiment of the present invention. In detail, FIG. 8A illustrates the signal strength of node A of FIG. 4, FIG. 8B illustrates the signal strength of node B, and FIG. 8C illustrates the signal strength of node C. It is assumed that the IF frequency is 44 MHz.

As shown in FIG. 8A, the RF broadcasting signal received from the antenna 310 comprises a desired signal and an image signal, which differ by 88 MHz.

Both signals are extracted via the band selection module 331. Both signals may be illustrated as in FIG. 8B, assuming that the band selection module 331 extracts only the desired signal according to the control signal 339a. In other words, the desired signal and the image signal differ by 40 dB in Image-Rejection Rate (IRR).

Then, both signals are tuned to the band with the gain obtained through the input matching module 333a using the control signal 339b as a basis.

Only the desired signal is amplified since the input matching module 333a amplifies only the frequency band of the desired signal, assuming that the amplifier module 333b has a gain of 30 dB. Using the control signal 339d as a basis, the signal amplified by the amplifier module 333b is tuned to the frequency band with the gain obtained through the output matching module 333c, and the results are shown in FIG. 8.

Comparing the signal strength of node C illustrated in FIG. 4 with that of node A, the desired signal and the image signal differ by 70 dB in IRR, as illustrated in FIG. 8C, and therefore, the characteristics of image-rejection may be improved.

The characteristics of the channel selection may be improved and the IRR may be greatly increased, by concurrently controlling the frequency band characteristics of the band selection module 331 and those of the low noise amplifier module 333 based on the control signals 339a, 339b, and 339c provided by the tuner control module 339.

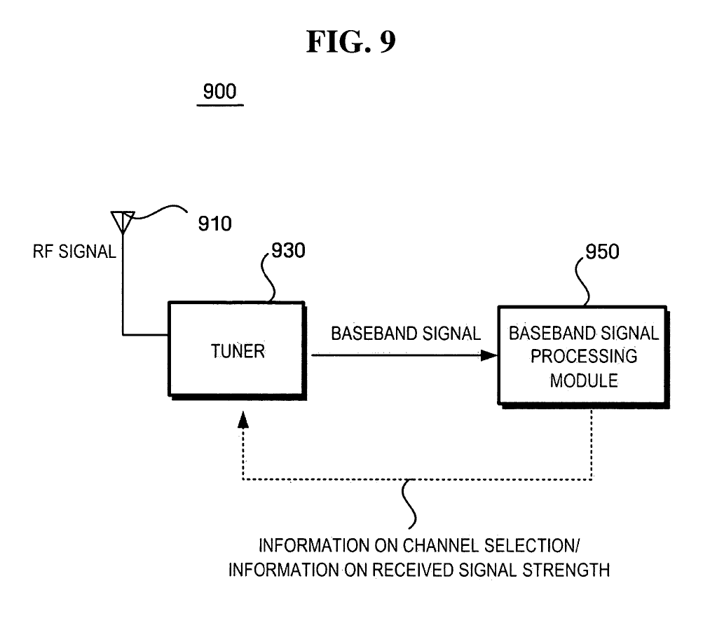

FIG. 9 is a block diagram illustrating the structure of a broadcasting signal receiver according to another exemplary embodiment of the present invention.

According to FIG. 9, a broadcasting signal receiver 900 comprises an antenna 910, a tuner 930, and a baseband signal processing module 950.

The antenna 910 receives an RF broadcasting signal, converts it to an electrical signal, and transmits it via a wire.

The tuner 930 converts the RF broadcasting signal received through the antenna 910 into a baseband signal based upon the information on the channel selection information.

The baseband signal processing module 950 receives and processes the baseband signal provided by the tuner 930. The baseband signal processing module 950 may include a demodulator to demodulate the baseband signal, and transfers the channel selection information to the tuner 930. Then, the tuner 330 converts only the RF signal within the band of the selected channel into the baseband signal.

The baseband signal processing module 950 controls the strength of the RF signal and the strength of the converted baseband signal, by providing RSSIs.

The tuner 930 corresponds in structure to the tuner illustrated in FIG. 4, except that the mixer module 335, and the IF signal processing module 337 provide functions to process the baseband signal.

In other words, the mixer module 335 converts the RF broadcasting signal into the baseband signal. The IF signal processing module 337 extracts the converted baseband signal, and controls the gain of the filtered signal so that it can be controlled by the baseband signal processing module 950.

The terrestrial/cable broadcasting signal receiver according to exemplary embodiments of the present invention performs better than the conventional terrestrial/cable broadcasting signal receiver.

Exemplary embodiments of the present invention can also be effectively applied to a mobile device that can receive terrestrial/cable broadcasting channels, by simplifying the structure of the tuner and reducing power consumption.

The exemplary embodiments of the present invention have been explained with reference to the accompanying drawings, but it will be apparent to those skilled in the art that various modifications and changes may be made thereto without departing from the scope and spirit of the invention. Therefore, it should be understood that the above exemplary embodiments are not restrictive but illustrative in all aspects.

What is claimed is:

1. A tuner comprising:
a band selection module that selects an RF broadcasting signal within a frequency band corresponding to a selected channel; and
a low noise amplifier module that amplifies the selected RF broadcasting signal with a specific received signal strength indicator (RSSI) to produce an RF broadcasting signal with a specific gain.

2. The tuner of claim 1, wherein the low noise amplifier module comprises:
an amplifier module that amplifies the selected RF broadcasting signal; and
an input matching module and an output matching module that tune in frequencies so that the selected RF broadcasting signal has a specific gain.

3. The tuner of claim 2, wherein the input matching module and the output matching module comprise multiple impedance blocks.

4. The tuner of claim 3, wherein the frequency band is determined by a combination of the multiple impedance blocks

5. The tuner of claim 2, further comprising a tuner control module that provides information on the channel selection to the band selection module, the input matching module, and the output matching module, and that provides the RSSI to the amplifier module.

6. The tuner of claim 1, further comprising:
a mixer module that converts the amplified RF broadcasting signal into an IF signal; and
an IF signal processing module that extracts the IF signal and controls a level of filtered signal so as to corresponds to the RSSI.

7. The tuner of claim 1, further comprising a mixer module that converts the amplified RF broadcasting signal into a baseband signal.

8. The tuner of claim 1, wherein information on the channel selection is digitized.

9. The tuner of claim 1, wherein the RF broadcasting signal is a digital broadcasting signal or a cable broadcasting signal.

10. A broadcasting signal receiver comprising:
a tuner that receives RF broadcasting signals and selects an RF broadcasting signal in a frequency band corresponding to a selected channel, and downshifts the frequency band after amplifying the selected RF broadcasting signal so that the selected RF broadcasting signal has a gain within the frequency band; and
a signal processing module that processes a signal in the downshifted frequency band.

11. The receiver of claim 10, wherein the tuner comprises:
a band selection module that selects an RF broadcasting signal within the frequency band;
an amplifier module that amplifies the selected RF broadcasting signal;
an input matching module and output matching module formed on the front and back stage of the amplifier module, that tune in frequencies so that the selected RF broadcasting signal has a gain in the frequency band; and
a mixer module that downshifts the frequency band of the amplified signal.

12. The receiver of claim 10, wherein the downshifted frequency band is an intermediate band.

13. The receiver of claim 10, wherein the downshifted frequency band is a baseband.

14. The receiver of claim 10, wherein information on the channel selection is digitized.

15. The receiver of claim 10, wherein the RF broadcasting signal is a digital broadcasting signal or a cable broadcasting signal.
